(19) United States
(12) Patent Application Publication
(10) Pub. No.: US 2026/0246945 A1
(43) Pub. Date: Aug. 20, 2026

(54) Enhanced Multi-Stage Intra Prediction

(71) Applicant: Google LLC, Mountain View, CA (US)

(72) Inventors: Jingning Han, Santa Clara, CA (US); Paul Wilkins, Cambridge (GB); Yaowu Xu, Saratoga, CA (US)

(21) Appl. No.: 18/872,121

(22) PCT Filed: Jun. 6, 2022
(86) PCT No.: PCT/US2022/032366

§ 371 Date: Dec. 5, 2024

(51) Int. Cl. H04N 19/159; H04N 19/105; H04N 19/182; H04N 19/196; H04N 19/30; H04N 19/593

(52) U.S. Cl. CPC H04N 19/159; H04N 19/105; H04N 19/182; H04N 19/196; H04N 19/30; H04N 19/593

(57) ABSTRACT

Interleaved sets of lines of pixels of a block are sampled and intra predicted using the same or different intra prediction modes. According to an implementation, a first directional intra prediction mode is determined for first lines of pixels. The first lines of pixels are predicted using the first directional intra prediction mode and are thereafter reconstructed. Based on the first directional intra prediction mode, a second directional intra prediction mode is determined for second lines of pixels interleaving the first lines of pixels. The second lines of pixels are predicted using the second directional intra prediction mode and reconstructed first lines of pixels and are thereafter reconstructed. The second directional intra prediction mode may be inherited from the first directional intra prediction mode, and the sampling of the block may be based on a prediction directionality determined for the block.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

A method for decoding an encoded block according to an implementation of this disclosure comprises determining a first directional intra prediction mode for first lines of pixels within the encoded block, reconstructing the first lines of pixels using the first directional intra prediction mode, determining a second directional intra prediction mode for second lines of pixels interleaving the first lines of pixels within the encoded block based on the first directional intra prediction mode, reconstructing the second lines of pixels using the second directional intra prediction mode and at least the reconstructed first lines of pixels, and outputting a decoded block including the reconstructed first lines of pixels and the reconstructed second lines of pixels for storage or further processing.

In some implementations of the method, reconstructing the first lines of pixels comprises predicting the first lines of pixels according to the first directional intra prediction mode while skipping the second lines of pixels.

In some implementations of the method, the first lines of pixels are predicted using previously reconstructed pixels of one or more neighbor blocks of the encoded block, and the second lines of pixels are predicted using both the previously reconstructed pixels of the one or more neighbor blocks and the reconstructed first lines of pixels.

In some implementations of the method, the first lines of pixels are odd numbered rows or columns of the encoded block, and the second lines of pixels are even numbered rows or columns of the encoded block.

In some implementations of the method, the second directional intra prediction mode is inherited from the first directional intra prediction mode.

In some implementations of the method, pixels of the second lines of pixels are predicted using linear interpolation or polynomial interpolation performed against one or both of pixels of the first lines of pixels that are adjacent to the pixels of the second lines of pixels or pixels of the previously reconstructed pixels of the one or more neighbor blocks.

In some implementations of the method, the method comprises determining a spatial sampling for the encoded block, and splitting the encoded block into the first lines of pixels and the second lines of pixels according to the spatial sampling.

In some implementations of the method, the spatial sampling indicates to predict the encoded block using a pyramid pattern within which sets of lines of pixels including the first lines of pixels and the second lines of pixels are hierarchically arranged, and the method comprises determining, based on the second directional intra prediction mode, a third directional intra prediction mode for third lines of pixels interleaving the first lines of pixels and the second lines of pixels within the encoded block at a level of the pyramid pattern that is hierarchically below a level to which the second lines of pixels correspond, and reconstructing the third lines of pixels using the third directional intra prediction mode and at least the reconstructed second lines of pixels.

In some implementations of the method, the third directional intra prediction mode is inherited from the second directional intra prediction mode, and wherein the third lines of pixels are reconstructed using previously reconstructed pixels of one or more neighbor blocks of the encoded block, the reconstructed first lines of pixels, and the reconstructed second lines of pixels.

In some implementations of the method, the method comprises determining a rate of change representing differences between the previously reconstructed pixels of the one or more neighbor blocks, the reconstructed first lines of pixels, and the reconstructed second lines of pixels, and refining the third directional intra prediction mode using a filter extrapolated based on the rate of change.

In some implementations of the method, the spatial sampling is determined using one or more syntax elements encoded to a bitstream including the encoded block.

In some implementations of the method, a first quantizer delta value used for the first lines of pixels and a second quantizer delta value used for the second lines of pixels are derived from the bitstream, and the second quantizer delta value is encoded to the bitstream relative to one or both of a quantizer used for the first lines of pixels or the first quantizer delta value.

In some implementations of the method, the first directional intra prediction mode is the initial directional prediction mode, and the spatial sampling indicates to split the encoded block into a number of sets of lines of pixels equal to a power of two.

An apparatus for decoding an encoded block from a bitstream according to an implementation of this disclosure comprises a memory and a processor configured to execute instructions stored in the memory to reconstruct first lines of pixels within the encoded block using a first directional intra prediction mode, reconstruct second lines of pixels interleaving the first lines of pixels within the encoded block using the reconstructed first lines of pixels and a second directional intra prediction mode determined based on the first directional intra prediction mode, and output a decoded block including the reconstructed first lines of pixels and the reconstructed second lines of pixels for storage or further processing.

In some implementations of the apparatus, the processor is configured to execute the instructions to determine the first lines of pixels based on a spatial sampling for the encoded block, wherein the spatial sampling is based on the first directional intra prediction mode.

In some implementations of the apparatus, the processor is configured to execute the instructions to decode the initial intra prediction mode from a bitstream to which the encoded block is encoded, decode the spatial sampling from the bitstream, and split the encoded block into at least the first lines of pixels and the second lines of pixels according to the spatial sampling.

In some implementations of the apparatus, multiple sets of lines of pixels within the encoded block including the first lines of pixels and the second lines of pixels are predicted in a pyramid pattern.

A non-transitory computer-readable storage device according to an implementation of this disclosure includes program instructions executable by one or more processors that, when executed, cause the one or more processors to perform operations for decoding an encoded block, in which the operations comprise splitting the encoded block into first lines of pixels and second lines of pixels according to a spatial sampling for the encoded block, reconstructing first lines of pixels within the encoded block using a first directional intra prediction mode, reconstructing second lines of pixels interleaving the first lines of pixels within the encoded block using the reconstructed first lines of pixels and a second directional intra prediction mode inherited from the first directional intra prediction mode, and output a decoded block including the reconstructed first lines of pixels and the reconstructed second lines of pixels for storage or further processing.

In some implementations of the non-transitory computer-readable storage device, the spatial sampling identifies the first lines of pixels as either odd-numbered rows within the encoded block or odd-numbered columns within the encoded block.

In some implementations of the non-transitory computer-readable storage device, the spatial sampling is determined using a decision tree.

These and other aspects of this disclosure are disclosed in the following detailed description of the implementations, the appended claims, and the accompanying figures.

### BRIEF DESCRIPTION OF THE DRAWINGS

The description herein makes reference to the accompanying drawings described below, wherein like reference numerals refer to like parts throughout the several views.

FIG. 1 is a schematic of an example of a video encoding and decoding system.

FIG. 2 is a block diagram of an example of a computing device that can implement a transmitting station or a receiving station.

FIG. 3 is a diagram of an example of a video stream to be encoded and decoded.

FIG. 4 is a block diagram of an example of an encoder.

FIG. 5 is a block diagram of an example of a decoder.

FIG. 6 is an illustration of examples of portions of a video frame.

FIG. 7 is a block diagram of a prediction stage of an encoder used for enhanced multi-stage intra prediction.

FIG. 8 is a block diagram of a prediction stage of a decoder used for enhanced multi-stage intra prediction.

FIG. 9 is an illustration of an example of a block in which pixels are split into first and second lines and predicted using a same intra prediction direction.

FIG. 10 is an illustration of an example of a block in which pixels are split into first and second lines and predicted using different intra prediction directions.

FIG. 11 is an illustration of an example of a block in which pixels are split into more than two sets of lines.

FIG. 12 is an illustration of an example of a block in which a sub-sampled 45-degree prediction directionality is determined for identifying the first lines of pixels.

FIG. 13 is an illustration of an example of a block in which pixels are predicted in a pyramid pattern.

FIG. 14 is a flowchart diagram of an example of a technique for enhanced multi-stage intra prediction.

### DETAILED DESCRIPTION

Video compression schemes may include breaking respective images, or frames, into smaller portions, such as blocks, and generating an encoded bitstream using techniques to limit the information included for respective blocks thereof. The bitstream can be decoded to re-create the source images from the limited information. Encoding blocks to or decoding blocks from a bitstream can include predicting the values of pixels or blocks based on similarities with other pixels or blocks in the same frame that have already been coded. Those similarities can be determined using one or more intra prediction modes. Intra prediction modes attempt to predict the pixel values of a block using pixels peripheral to the block (e.g., pixels that are in the same frame as the block, but which are outside the block). During encoding, the result of an intra-prediction mode performed against a block is a prediction block. A prediction residual can be determined based on a difference between the pixel values of the block and the pixel values of the prediction block. The prediction residual and the intra prediction mode used to ultimately obtain that prediction residual can then be encoded to a bitstream. During decoding, the prediction residual is reconstructed into a block using a prediction block produced based on the intra prediction mode and is thereafter included in an output video stream.

There may be multiple intra prediction modes available for predicting a block. Amongst those multiple intra prediction modes are various directional intra-prediction modes that can be used to perform prediction along different directions with respect to the pixel values of a block. For example, the AV1 codec supports 56 directional intra prediction modes, which include seven angled variations for each of eight base directional modes (−9, −6, −3, 0, +3, +6, and +9 degree directionalities for V_PRED, H_PRED, D45_PRED, D67_PRED, D113_PRED, D135_PRED, D157_PRED, and D203_PRED). Each of these 56 directional intra prediction modes uses reconstructed values in neighbor blocks (e.g., using filter interpolation) to determine final prediction values for a current block.

While the availability of a large number of intra prediction mode options may tend to improve the overall quality of prediction and thus of reconstructed blocks encoded using such intra prediction modes, there remain opportunities to further improve intra prediction processing. In particular, generally, pixel values may be assumed to be spatially correlated such that pixel values near one another are more likely to be similar than pixel values that are far apart. As such, a given intra prediction mode determined for a block may not accurately represent all features within that block. One option to address this may include sampling pixel values within various portions of the block to determine intra prediction modes that best fit the video information within those respective block portions. The method of sampling the pixel values of the block and the various intra prediction modes determined based on that sampling may then be signaled to a decoder within a bitstream. However, such signaling requires bits to be communicated to a decoder, and this additional signaling overhead introduced for the block sampling and various intra prediction modes may undesirably offset gains otherwise achieved from the video compression.

Implementations of this disclosure address problems such as these using enhanced multi-stage intra prediction in which interleaved sets of lines of pixels of a block are sampled and intra predicted using the same or different intra prediction modes. An initial prediction mode for the block is determined using, for example, the reconstructed pixel values of pixels in neighboring blocks to create a prediction block that best matches the pixel values of the block. The block is sampled based on the initial prediction mode to split the block into multiple sets of lines of pixels including at least a first lines of pixels and a second lines of pixels, in which the first lines of pixels are predicted first using a first intra prediction mode and the reconstructed pixel values of the neighbor blocks and the second lines of pixels are predicted using a second intra prediction mode and using reconstructed values of the first lines of pixels and the reconstructed pixel values of the neighbor blocks.

The first and second intra prediction modes may be the same or different intra prediction modes. For example, in some cases, the first intra prediction mode can be inherited for use with the second lines of pixels as the second intra prediction mode. In another example, the second intra prediction mode can be determined by refining a directionality of the first intra prediction mode according to pixel values of the second lines of pixels. In yet another example, the second intra prediction mode can be derived from the first intra prediction mode using the same directionality but a different filtering method determined using newly-available reconstructed pixel values. The intra prediction mode used for a given line of pixels may thus be used to determine the intra prediction mode for a next line of pixels. Relatedly, that next line of pixels may be predicted using reconstructed pixel values from the preceding lines of pixels and, in at least some cases, from one or more neighbor blocks. The implementations of this disclosure may use only directional intra prediction modes, combinations of directional intra prediction modes and other intra prediction modes, or only intra prediction modes other than directional intra prediction modes.

According to one implementation, a first directional intra prediction mode is determined for first lines of pixels within a block. The first lines of pixels are predicted using the first directional intra prediction mode and reconstructed pixel values of one or more neighbor blocks of the block and thereafter reconstructed into reconstructed first lines of pixels. A second directional intra prediction mode is determined for second lines of pixels interleaving the first lines of pixels within the block based on the first directional intra prediction mode. The second lines of pixels are predicted using the second directional intra prediction mode, the reconstructed first lines of pixels, and/or the reconstructed pixel values of the one or more neighbor blocks and thereafter reconstructed. During encoding, the block, once coded and reconstructed, may be used for intra prediction of another block within the same frame. During decoding, a decoded block including the reconstructed first and second lines of pixels may be output for storage or further processing. In some cases, the block may be split into more than two sets of lines of pixels. The prediction in such a case is sequentially performed starting with the first lines of pixels, then the second lines of pixels, and so on, noting that the intra prediction mode to use for a given set of lines of pixels is derivable at least from the set of lines of pixels preceding it. For example, a spatial sampling strategy for the block may indicate to split the block into a number of sets of lines of pixels equal to a power of 2, such as 2, 4, 8, or 16 sets of lines of pixels. In such a case, a third directional intra prediction mode may be determined for the third lines of pixels based on the second directional intra prediction mode, a fourth directional intra prediction mode may be determined for the fourth lines of pixels based on the third directional intra prediction mode, and so on.

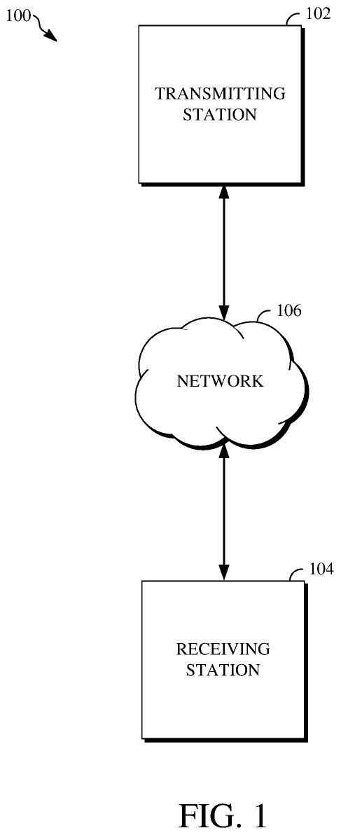

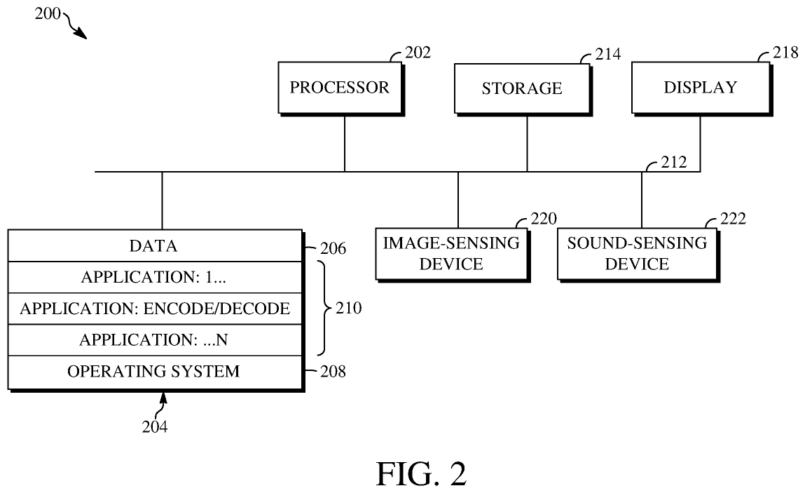

Further details of techniques for enhanced multi-stage intra prediction are described herein with initial reference to a system in which such techniques can be implemented. FIG. 1 is a schematic of an example of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used. e.g., a video streaming protocol based on the Hypertext Transfer Protocol (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

In some implementations, the video encoding and decoding system 100 may instead be used to encode and decode data other than video data. For example, the video encoding and decoding system 100 can be used to process image data. The image data may include a block of data from an image. In such an implementation, the transmitting station 102 may be used to encode the image data and the receiving station 106 may be used to decode the image data.

Alternatively, the receiving station 106 can represent a computing device that stores the encoded image data for later use, such as after receiving the encoded or pre-encoded image data from the transmitting station 102. As a further alternative, the transmitting station 102 can represent a computing device that decodes the image data, such as prior to transmitting the decoded image data to the receiving station 106 for display.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read-only memory (ROM) device or a random-access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include encoding and/or decoding software that performs, amongst other things, enhanced multi-stage intra prediction as described herein.

The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200.

Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

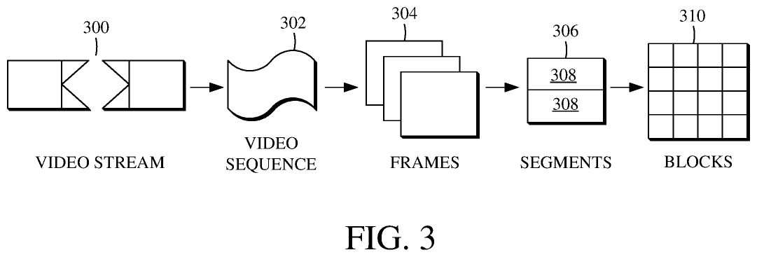

FIG. 3 is a diagram of an example of a video stream 300 to be encoded and decoded. The video stream 300 includes a video sequence 302. At the next level, the video sequence 302 includes a number of adjacent video frames 304. While three frames are depicted as the adjacent frames 304, the video sequence 302 can include any number of adjacent frames 304. The adjacent frames 304 can then be further subdivided into individual video frames, for example, a frame 306.

At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, N×M pixels in the frame 306, in which N and M may refer to the same integer value or to different integer values. The blocks 310 can also be arranged to include data from one or more segments 308 of pixel data. The blocks 310 can be of any suitable size, such as 4×4 pixels, 8×8 pixels, 16×8 pixels, 8×16 pixels, 16×16 pixels, or larger up to a maximum block size, which may be 128×128 pixels or another N×M pixels size.

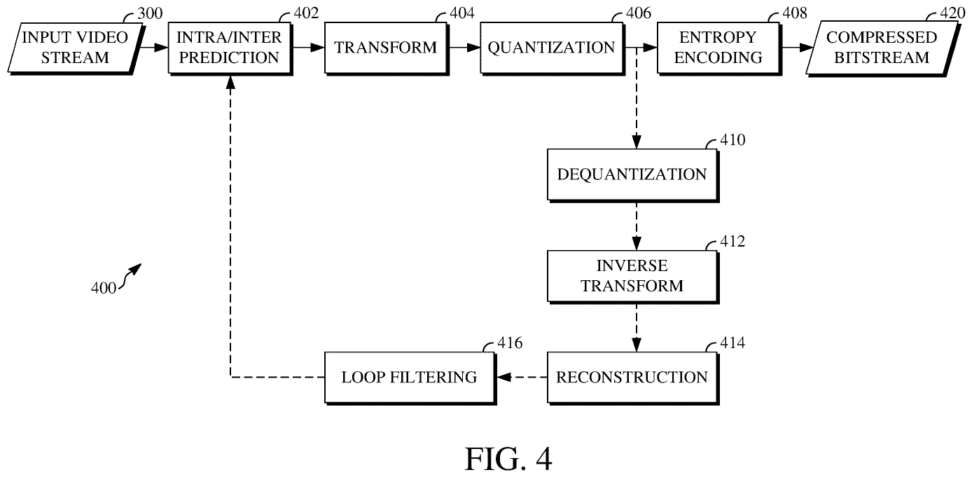

FIG. 4 is a block diagram of an example of an encoder 400. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In some implementations, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

In some cases, the functions performed by the encoder 400 may occur after a filtering of the video stream 300. That is, the video stream 300 may undergo pre-processing according to one or more implementations of this disclosure prior to the encoder 400 receiving the video stream 300. Alternatively, the encoder 400 may itself perform such pre-processing against the video stream 300 prior to proceeding to perform the functions described with respect to FIG. 4, such as prior to the processing of the video stream 300 at the intra/inter prediction stage 402.

When the video stream 300 is presented for encoding after the pre-processing is performed, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding or arithmetic coding. The compressed bitstream 420 can also be referred to as an encoded video stream or encoded video bitstream, and the terms will be used interchangeably herein.

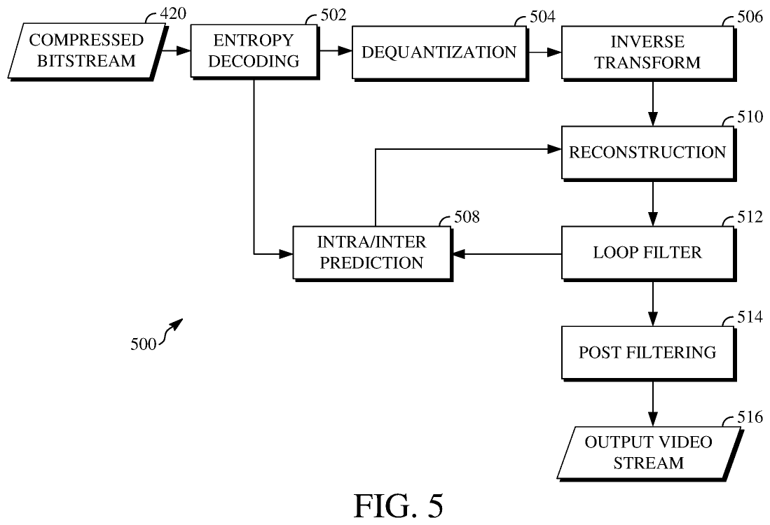

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual).

At the reconstruction stage 414, the prediction block that was predicted at the intra/inter prediction stage 402 can be added to the derivative residual to create a reconstructed block. The loop filtering stage 416 can apply an in-loop filter or other filter to the reconstructed block to reduce distortion such as blocking artifacts. Examples of filters that may be applied at the loop filtering stage 416 include, without limitation, a deblocking filter, a directional enhancement filter, and a loop restoration filter.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of an example of a decoder 500. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106. In some implementations, the decoder 500 is a hardware decoder.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filter stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Examples of filters that may be applied at the loop filtering stage 512 include, without limitation, a deblocking filter, a directional enhancement filter, and a loop restoration filter. Other filtering can be applied to the reconstructed block. In this example, the post filter stage 514 is applied to the reconstructed block to reduce blocking distortion, and the result is output as the output video stream 516. The output video stream 516 can also be referred to as a decoded video stream, and the terms will be used interchangeably herein.

Other variations of the decoder 500 can be used to decode the compressed bitstream 420. In some implementations, the decoder 500 can produce the output video stream 516 without the post filter stage 514 or otherwise omit the post filter stage 514.

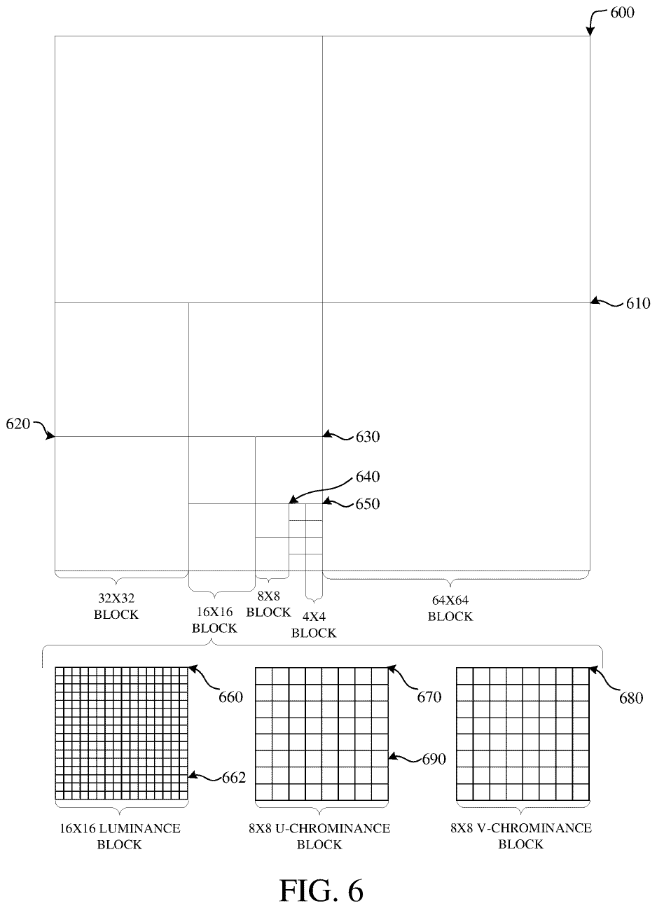

FIG. 6 is an illustration of examples of portions of a video frame 600, which may, for example, be the frame 306 shown in FIG. 3. The video frame 600 includes a number of 64×64 blocks 610, such as four 64×64 blocks 610 in two rows and two columns in a matrix or Cartesian plane, as shown. Each 64×64 block 610 may include up to four 32×32 blocks 620. Each 32×32 block 620 may include up to four 16×16 blocks 630. Each 16×16 block 630 may include up to four 8×8 blocks 640. Each 8×8 block 640 may include up to four 4×4 blocks 950. Each 4×4 block 950 may include 16 pixels, which may be represented in four rows and four columns in each respective block in the Cartesian plane or matrix. In some implementations, the video frame 600 may include blocks larger than 64×64 and/or smaller than 4×4. Subject to features within the video frame 600 and/or other criteria, the video frame 600 may be partitioned into various block arrangements.

The pixels may include information representing an image captured in the video frame 600, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used, wherein N and M are different numbers. For example, 32×64 blocks, 64×32 blocks, 16×32 blocks, 32×16 blocks, or any other size blocks may be used. In some implementations, N×2N blocks, 2N×N blocks, or a combination thereof, may be used.

In some implementations, coding the video frame 600 may include ordered block-level coding. Ordered block-level coding may include coding blocks of the video frame 600 in an order, such as raster-scan order, wherein blocks may be identified and processed starting with a block in the upper left corner of the video frame 600, or portion of the video frame 600, and proceeding along rows from left to right and from the top row to the bottom row, identifying each block in turn for processing. For example, the 64×64 block in the top row and left column of the video frame 600 may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block of the video frame 600 may include using quad-tree coding, which may include coding smaller block units within a block in raster-scan order. For example, the 64×64 block shown in the bottom left corner of the portion of the video frame 600 may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, coding the video frame 600 may include encoding the information included in the original version of the image or video frame by, for example, omitting some of the information from that original version of the image or video frame from a corresponding encoded image or encoded video frame. For example, the coding may include reducing spectral redundancy, reducing spatial redundancy, or a combination thereof. Reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of the video frame 600, and using a relatively small amount of information to represent each corresponding chrominance component for the portion of the video frame 600. For example, a portion of the video frame 600 may be represented by a high-resolution luminance component, which may include a 16×16 block of pixels, and by two lower resolution chrominance components, each of which represents the portion of the image as an 8×8 block of pixels. A pixel may indicate a value, for example, a value in the range from 0 to 255, and may be stored or transmitted using, for example, eight bits. Although this disclosure is described in reference to the YUV color model, another color model may be used. Reducing spatial redundancy may include transforming a block into the frequency domain using, for example, a discrete cosine transform (DCT). For example, a unit of an encoder may perform a discrete cosine transform using transform coefficient values based on spatial frequency.

Although described herein with reference to matrix or Cartesian representation of the video frame 600 for clarity, the video frame 600 may be stored, transmitted, processed, or a combination thereof, in a data structure such that pixel values may be efficiently represented for the video frame 600. For example, the video frame 600 may be stored, transmitted, processed, or any combination thereof, in a two-dimensional data structure such as a matrix as shown, or in a one-dimensional data structure, such as a vector array. Furthermore, although described herein as showing a chrominance subsampled image where U and V have half the resolution of Y, the video frame 600 may have different configurations for the color channels thereof. For example, referring still to the YUV color space, full resolution may be used for all color channels of the video frame 600. In another example, a color space other than the YUV color space may be used to represent the resolution of color channels of the video frame 600.

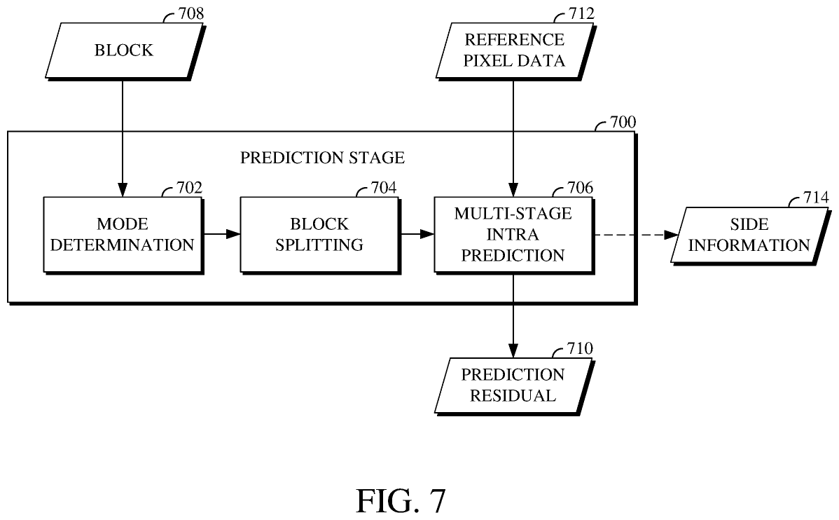

FIG. 7 is a block diagram of a prediction stage 700 of an encoder used for enhanced multi-stage intra prediction. The prediction stage 700 may, for example, be the intra/inter prediction stage 402 of the encoder 400 shown in FIG. 4. The prediction stage 700 includes functionality for performing enhanced multi-stage intra prediction against blocks during encoding. In some cases, a video frame within which the blocks predicted using the prediction stage 700 are located may be a video frame that only includes blocks to be intra-predicted, such as a key frame or an I-frame. In other cases, the video frame may be a video frame that includes one or more blocks to be intra-predicted and one or more blocks to be inter-predicted.

The functionality of the prediction stage 700 for performing enhanced multi-stage intra prediction is represented by sub-stages, including a mode determination sub-stage 702, a block splitting sub-stage 704, and a multi-stage intra prediction sub-stage 706. The sub-stages 702 through 706 take as input a block 708 and produce as output a prediction residual 710 for each set of lines of pixels of the block 708, which prediction residual 710 may thereafter be quantized, transformed, entropy coded, and written to a bitstream, such as described with respect to the stages 404 through 408 shown in FIG. 4.

The mode determination sub-stage 702 processes pixel data of the block 708 to determine an initial prediction mode for the block 708. The initial prediction mode is an intra prediction mode usable to predict the block 708 determined based on values of reconstructed pixels from one or more neighboring blocks of the block 708 that sit along a boundary with the block 708. For example, where a raster order is followed for encoding blocks of a subject video frame, the initial prediction mode for the block 708 may be determined based on one or more reconstructed pixels of a left neighbor block of the block 708 along a boundary between the left neighbor block and the block 708 and/or one or more reconstructed pixels of an above neighbor block of the block 708 along a boundary between the above neighbor block and the block 708. A neighbor block from which one or more reconstructed pixel values are used to determine the initial prediction mode for the block 708 may be an intra-predicted block or an inter-predicted block. Where the initial prediction mode is a directional intra prediction mode, determining the initial prediction mode may include determining both the prediction directionality for the initial prediction mode and the mode of prediction (i.e., the manner by which new values are derived along the axis of the subject prediction directionality). In such a case, the expression of the initial prediction mode will be understood to refer to both the mode and the directionality.

To determine the initial prediction mode, candidate predictions may be performed against one or more pixels of the block 708 (e.g., the entire block 708 or a subset of pixels on boundaries with the subject neighbor blocks) using one or more different intra prediction modes. Examples of intra prediction modes that may be used to determine the candidate predictions include, but are not limited to, directional intra prediction modes (e.g., the 56 directional intra prediction modes supported by the AV1 codec), non-directional intra smooth prediction modes (e.g., DC_PRED, TM_PRED, SMOOTH_V_PRED, SMOOTH_H_PRED, or SMOOTH_PRED), recursive intra prediction modes, chroma from luma intra prediction modes, intra block copy prediction modes, or color palette prediction modes. A candidate prediction resulting in a lowest residual error or having a lowest score (e.g., a lowest rate-distortion optimization score or another score computed based on a peak signal-to-noise ratio (PSNR) or like metric) may be determined as the initial intra prediction mode.

The block splitting sub-stage 704 determines how to split the block 708 into multiple sets of lines of pixels for performing intra prediction. As used herein, a line of pixels may refer to one or more pixels along a straight line in any direction at any angle across some or all of a block. The lines of pixels into which the block 708 is split are parallel to one another and thus are oriented in the same direction. The lines of pixels of a given set generally will, but need not always, be spaced one or more lines apart within the block 708. As such, sets of lines of pixels are interleaved within the block 708. For example, where the block 708 is split into two sets of lines of pixels including first lines of pixels and second lines of pixels, the first lines of pixels may be the odd numbered rows or columns of the block 708 and the second lines of pixels may be the even numbered rows or columns of the block 708. In such a case, the interleaving of the first and second lines of pixels is such that the first and second lines of pixels alternate with each row or column of the block 708.

Splitting the block 708 into the multiple sets of lines of pixels includes determining a spatial sampling indicating a manner by which to sample pixel values within the block 708 based on the initial intra prediction mode determined by the mode determination sub-stage 702 and splitting the block 708 into the multiple sets of lines of pixels according to the spatial sampling. To determine the spatial sampling, the block splitting sub-stage 704 uses the initial intra prediction mode to determine which line of pixels within the block 708 to predict first and optionally a complexity of the features within the block 708 or some measure thereof. The line of pixels to predict first is a first line of first lines of pixels and may, for example, be a top-most row of the block 708 or a left-most column of the block 708. For example, where the initial intra prediction mode is a horizontal intra prediction mode, the first line of pixels to be predicted may be a left-most column of the block 708. In another example, where the initial intra prediction mode is a 45- or 135-degree intra prediction mode, the first line of pixels to be predicted may be either a left-most column of the block 708 or a top-most row of the block 708 (i.e., because the prediction directionality is equidistant to the horizontal and vertical directions).

The complexity of features depicted within the block 708 may be determined based on an initial sampling of pixel values throughout some or all of the block 708. For example, a low complexity may be determined where most or all of the sub-sampled pixel values are of the same or a similar value (e.g., denoting that the block 708 probably depicts a solid color or colors very close to one another, such as within a few shades of one another). In another example, a high complexity may be determined where the sub-sampled pixel values have multiple dissimilar values, which may thus indicate that there are either multiple objects depicted within the block 708 or multiple features (e.g., different edges, colors, or the like) of one or more objects depicted within the block 708. Alternatively, the complexity of features may be inferred based on a size of the block 708. For example, a smaller block may generally be expected to have less complex features than a larger block, given that the larger block is capable of including a larger number and thus wider variety of pixel values.

The block 708 is then split into the multiple sets of lines of pixels. In particular, where there is a high complexity of features within the block 708 (e.g., based on a pixel value variation above a threshold), the block 708 may be split into a set of first lines of pixels and a set of second lines of pixels. However, where there is a low complexity of features within the block 708 (e.g., based on the pixel value variation being below that same threshold or below a different threshold), the block 708 may be split into a larger number of sets of lines of pixels, such as three or four sets of lines of pixels.

In some implementations, a decision tree may be used to determine the number of sets of lines of pixels into which to split the block 708 based on the initial intra prediction mode and the complexity of features within the block 708. For example, the decision tree may evaluate prediction outcomes resulting from different numbers and/or arrangements of sets of lines of pixels into which the block 708 may be split. The block 708 may accordingly be split based on an outcome having a highest score, an outcome resulting in a lowest prediction error, or an outcome based on an optimal balance between a final encoding cost in bits for the block and either its prediction error or the reconstructed error after application of a quantized residual (e.g., via rate-distortion optimization).

The multi-stage intra prediction sub-stage 706 performs intra prediction against sets of lines of pixels of the block 708 in stages, starting with the first lines of pixels. The multi-stage intra prediction sub-stage 706 performs intra prediction against set of lines of pixels using an intra prediction mode determined for that set of lines of pixels. For example, the first lines of pixels are predicted using a first intra prediction mode, the second lines of pixels are predicted using a second intra prediction mode, and so on. In some examples, all of the sets of lines of pixels of the block 708 may be predicted using the same intra prediction mode. In such a case, the first intra prediction mode used for the first lines of pixels and the second intra prediction mode used for the second lines of pixels may be the same intra prediction mode, and the second and subsequent intra prediction modes may be considered to have been inherited from the first intra prediction mode. In other examples, multiple sets of lines of pixels of the block 708 may share a same intra prediction mode while other sets of lines of pixels of the block 708 use a different intra prediction mode. In still further examples, each set of lines of pixels of the block 708 may use a different intra prediction mode.

The multi-stage intra prediction sub-stage 706 performs intra prediction against sets of lines of pixels of the block 708 using reference pixel data 712, which includes values of reconstructed pixels from one or more sources. Thus, the intra prediction mode to use to predict a given set of lines of pixels is determined based on values of reconstructed pixels available for the prediction of the given set of lines of pixels. In this way, each stage of the multi-stage intra prediction process may benefit from the prediction of and reconstruction of (i.e., including application of any quantized prediction residual) previous sets of lines of pixels. For example, the intra prediction mode for predicting the first lines of pixels of the block 708 may be determined using values of reconstructed pixels of one or more neighbor blocks of the block 708 (e.g., reconstructed pixels along one or more boundaries between the block 708 and the one or more neighbor blocks). At the next stage of the multi-stage prediction, an intra prediction mode for predicting the second lines of pixels of the block 708 may be determined using values of reconstructed pixels of the first lines of pixels. In some cases, the intra prediction mode for predicting the second lines of pixels may be determined using the values of the reconstructed pixels of the first lines of pixels and the values of the reconstructed pixels of the one or more neighbor blocks.

Once a given set of lines of pixels is predicted, the prediction residual 710 representing the difference between the actual and predicted values for the given set of lines of pixels of the block 708 is generated. That prediction residual 710 for that given set of lines of pixels is further processed as part of the encoding of the video frame that includes the block 708, including by reconstructing the lines of pixels by adding the prediction residual 710 to the predicted values for the lines of pixels to produce reconstructed pixel values for those lines of pixels, which will be used for the prediction of the next lines of pixels. Thus, at each stage of the multi-stage intra prediction disclosed herein, the pixel values of a given set of lines that are reconstructed using the prediction residual 710 will have comparable accuracy for intra predicting a next set of lines of pixels as the pixel values in the one or more neighbor blocks of the block 708.

Determining an intra prediction mode for each set of lines of pixels enables potential quality improvements by using more accurate reference data to more closely predict pixel values within the block 708. That is, each pixel in a given line of pixels may be more accurately predicted than pixels in a previously predicted line of pixels because each pixel in the given line of pixels is predicted by one or more closely adjacent and fully reconstructed pixel values. For example, regardless of whether a prediction directionality changes between intra prediction modes used in subsequent sets of lines of pixels, the greater availability of adjacent, reconstructed pixel values will likely increase the prediction performance for a current line of pixels. Where the prediction directionality does change, however, as in some situations, a first intra prediction mode determined for first lines of pixels of the block 708 may be suitable for the first lines of pixels, but not precise enough to accurately predict the second lines of pixels without unnecessary error. In one example, this may be where the first intra prediction mode is a first directional intra prediction mode and a prediction directionality other than that associated with the first directional intra prediction mode is better suited to predict second lines of pixels. For example, the first directional intra prediction mode may be a vertical prediction mode, and a second directional intra prediction mode to use for predicting the second lines of pixels may be +3 or +6 degrees away from that vertical prediction mode directionality given differences in the feature depicted in the second lines of pixels. As such, a directional intra prediction mode may be refined between predictions of sets of lines of pixels while performing the multi-stage intra prediction for the block 708.

One reason why refinement may be desirable as further sets of lines of pixels are predicted is that additional reconstructed pixel values from lines of pixels that have already been predicted become available. For example, where the block 708 is separated into first lines of pixels and second lines of pixels in which the first and second lines of pixels are interleaved in alternating rows or columns, a first line of pixels that is between two second lines of pixels is predicted based on reconstructed pixel values of neighbor blocks that do not actually border that first line of pixels. However, after that first line of pixels and the one two rows or columns over are both predicted, the resulting reconstructed pixel values, which do border a second line of pixels, may be used to improve the prediction accuracy for the second line of pixels by providing reference values that immediately surround the pixels of that second line of pixels. As such, a prediction directionality of a first intra prediction mode may be refined by taking into account multiple reconstructed pixel values surrounding pixel values of a second line of pixels to be predicted. This may be especially useful, for example, where there is a gradient or other pattern of change along the direction of prediction, or where a steep-angled edge intersects the first and second lines of pixels.

The spatial sampling determined for the block 708, which guides the splitting of the block 708 into the various sets of lines of pixels, can, for example, indicate to interleave two or more sets of lines of pixels on a 1 to N pattern basis, in which N is an integer greater than 1 and corresponding to a last set of lines of pixels. Generally, the spatial sampling determined for the block 708 will follow powers of 2, such that the value of N will typically be equal to 2M, in which M is an integer starting at 1 for the second lines of pixels and increasing by 1 with each subsequent lines of pixels. However, this may not always be the case, as other spatial samplings may be used with the implementations of this disclosure.

Non-limiting examples of spatial samplings usable with the implementations of this disclosure will now be described. In one example, where the spatial sampling indicates to split the block 708 in a 1 to 2 pattern, two sets of lines of pixels are split from the block 708 and interleaved in an alternating pattern of first line, second line, first line, second line, first line, etc. In another example, where the spatial sampling indicates to split the block 708 in a 1 to 3 pattern, three sets of lines of pixels are split from the block 708 and interleaved in an alternating pattern of first line, second line, third line, first line, second line, third line, first line, etc. In some implementations, the spatial sampling may indicate a pattern other than one in which the sets of lines of pixels repeat in an evenly spaced pattern. For example, the spatial sampling may indicate to use a pyramid pattern in which the sets of lines of pixels are hierarchically arranged. In one example of a pyramid pattern, first lines of pixels are spaced apart by some number of lines (e.g., 4 or 8), second lines of pixels are spaced apart between the first lines of pixels, third lines of pixels are spaced apart between the second lines of pixels, and so on, based on the number of sets of lines of pixels. For example, with a pyramid pattern, subsequent sets of lines of pixels may potentially benefit from multiple sets of the same reconstructed pixel values surrounding them (e.g., in which two first lines surround two second lines that surround one third line), thereby potentially improving the quality of prediction for such subsequent sets of lines of pixels.

In some cases, the first intra prediction mode determined for predicting the first lines of pixels will be the same as the initial prediction mode determined at the mode determination sub-stage 702. For example, because the initial prediction mode is determined based on the pixel values of the block 708, if values of the first lines of pixels within the block 708 are representative of or otherwise similar to the pixel values of the block 708 (e.g., where the average pixel values of the block 708 are the same as the pixel values in the first lines of pixels), the first intra prediction mode may be the same as the initial intra prediction mode. However, in other cases, the first intra prediction mode will be different from the initial intra prediction mode. For example, the first intra prediction mode will be different where the pixel values of the first lines of pixels are not representative of the average pixel values throughout the block 708.

A spatial sampling strategy for the block 708 (e.g., indicating to split the block 708 and predict same in columns or rows) may be unclear where the initial intra prediction mode is not predominantly (e.g., within some threshold degree) horizontal or vertical, such as where the initial intra prediction mode is a 45-degree intra prediction mode or a 135-degree intra prediction mode (e.g., D45_PRED or D135_PRED, as expressed in the AV1 codec). For example, because 45-degree and 135-degree intra prediction modes use prediction directionalities that are equidistant to the vertical and horizontal intra prediction modes, a spatial sampling indicating to horizontally or vertically sample lines of pixels in the block 708 may be determined for the block 708 where the initial intra prediction mode is one such mode. The spatial sampling may thereafter be signaled within a bitstream to which results of the prediction of the block 708 are encoded. In some cases, the first lines of pixels may follow the 45-degree or 135-degree intra prediction mode such that the sets of lines of pixels will be diagonally oriented within the block 708, in which case the first intra prediction mode will be the initial intra prediction mode. In other such cases, however, the first lines of pixels may be determined to be vertically or horizontally oriented as either would be considered a reliable in between for the prediction directionality of the initial intra prediction mode.

As will be described below, a decoder receiving a bitstream to which the prediction residuals 710 for the various sets of lines of pixels are encoded may perform multi-stage intra prediction as part of a process for decoding encoded video data representing the block 708 within the bitstream based on the prediction residuals 710, one or more intra prediction modes signaled within the bitstream, and other encoded block data. In particular, at least a first intra prediction mode used to predict the first lines of pixels of the block may be signaled within the bitstream. In such a case, the intra prediction modes to use for all subsequent lines of pixels may be wholly or partially derived based on the first intra prediction mode signaled within the bitstream, and the decoder thus does not require additional information to predict the encoded block and thus to reconstruct the lines of pixels. Such inheritance or otherwise derivability of intra prediction modes may accordingly improve bitstream sizing by limiting or otherwise avoiding signaling overhead otherwise spent writing block information associated with the prediction of the block 708. In some cases, as necessary, one or more intra prediction modes for the block 708 beyond the first intra prediction mode may be signaled within the bitstream.

However, in some implementations, side information 714 associated with the prediction of the block 708 may be written to a bitstream to which the prediction residuals 710 for the various sets of lines of pixels are encoded, for use by a decoder in reconstructing the sets of lines of pixels. For example, the side information 714 may include or otherwise indicate one or more of an initial intra prediction mode determined for the block 708, one or more intra prediction modes determined and used for one or more sets of lines of pixels, a spatial sampling for the block 708, or the like. For example, the side information 714 may include data written to a block header of the block 708 within the bitstream to which the prediction residuals 710 for the various sets of lines of pixels are encoded. In another example, the side information 714 may include other data that will be made accessible in connection with the decoding of an encoded block associated with those prediction residuals 710.

In some implementations, quantizer delta values (e.g., delta values for quantization parameters) associated with the prediction residuals 710 may be written to the bitstream, either within the side information 714 or elsewhere. For example, various quantizer values may be signaled within the bitstream using deltas (referred to herein as quantizer delta values) or otherwise for the encoding of the prediction residuals 710 at each set of lines of pixels. In some cases, the quantizer delta values are determined at a quantization stage of the encoder that includes the prediction stage 700. In other cases, the quantizer delta values may be determined at the prediction stage 700, such as with access to quantization information from the quantization stage of the encoder. In either such case, in some implementations, the quantizer delta values may be specified at the block-level, frame-level, or sequence-level, or they could be derived or modified from a baseline value at the block-level, frame-level, or sequence-level based on block complexity. In some implementations, as the quantizer used for encoding lines of pixels becomes higher in successive lines of pixels, the quantizer delta value that is encoded to the bitstream for a given set of lines of pixels may be relative to the actual quantizer (and its corresponding quantizer delta value) used in a previous set of lines of pixels.

In some implementations, the mode of prediction used to predict a set of lines of pixels may use interpolation or extrapolation. For example, linear or polynomial interpolation may be performed to predict pixel values by interpolating from reconstructed pixel values nearby those pixel values to be predicted. In such a case, the interpolation predicts a pixel value based on an assumption that the pixel value will be somewhere in between the interpolated pixel values. In another example, contour modeling may be used to model edges within the block 708 by interpolating based on reconstructed pixel values from adjacent lines of pixels, as applicable. In yet another example, a rate of change or other gradient representing differences between previously reconstructed pixel values can be extrapolated to predict pixel values that will follow that rate of change or other gradient. In some such implementations, a prediction directionality used to predict a previous set of lines of pixels may be refined for use with a next set of lines to be predicted based on such an interpolation or extrapolation.

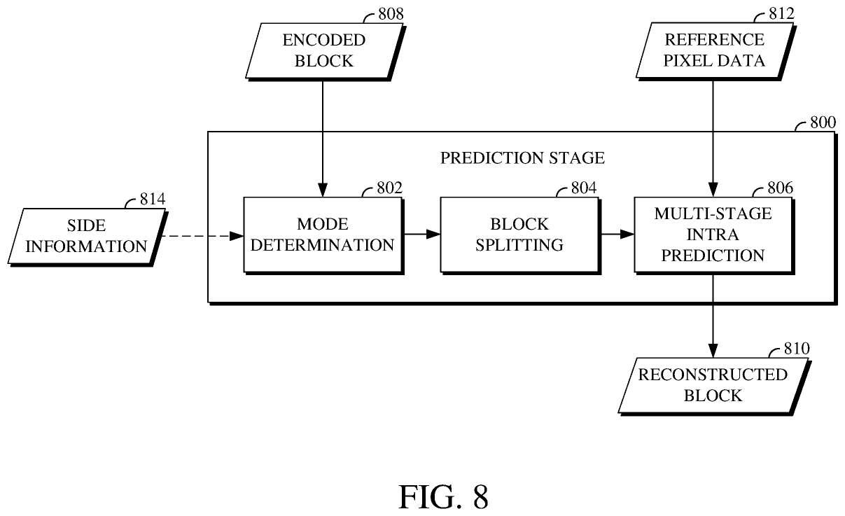

FIG. 8 is a block diagram of a prediction stage 800 of a decoder used for enhanced multi-stage intra prediction. The prediction stage 800 may, for example, be the intra/inter prediction stage 508 of the decoder 500 shown in FIG. 5. The prediction stage 800 includes functionality for performing enhanced multi-stage intra prediction against encoded blocks during decoding. In some cases, an encoded video frame within which the encoded blocks predicted using the prediction stage 700 are located may be an encoded video frame that only includes encoded blocks to be intra-predicted, such as a key frame or an I-frame. In other cases, the encoded video frame may be an encoded video frame that includes one or more encoded blocks to be intra-predicted and one or more encoded blocks to be inter-predicted.

The functionality of the prediction stage 800 for performing enhanced multi-stage intra prediction is represented by sub-stages, including a mode determination sub-stage 802, a block splitting sub-stage 804, and a multi-stage intra prediction sub-stage 806. The sub-stages 802 through 806 take as input an encoded block 808 and produce as output a reconstructed block 810, which may thereafter be optionally filtered and output to an output video stream, such as described with respect to the stages 512 through 514 shown in FIG. 5. In many cases, the functionality of the sub-stages 802 through 806 may be the same as that of the sub-stages 702 through 706 shown in FIG. 7. However, for clarity, such functionality will be redescribed with reference to the decoding process.

The mode determination sub-stage 802 determines one or more intra prediction modes to use to predict lines of pixels of the encoded block 808. For example, the bitstream in which the data associated with the encoded block 808 is read from may include encoded data indicating one or more intra prediction modes used by an encoder (e.g., at the prediction stage 700 shown in FIG. 7) to determine prediction residuals for the encoded block 808, in which each such prediction residual corresponds to a different set of lines of pixels of the encoded block 808. In particular, a first intra prediction mode used to predict first lines of pixels of the encoded block 808 may be read from the bitstream by the mode determination sub-stage 802. In some implementations, rather than obtain or otherwise use an intra prediction mode signaled within the bitstream, the mode determination sub-stage 802 may process data associated with the encoded block 808 as described above with respect to the mode determination sub-stage 702 shown in FIG. 7 to determine one or more prediction modes for the encoded block 808.

The block splitting sub-stage 804 determines how to split the encoded block 808 into multiple sets of lines of pixels for performing intra prediction. As is described above with respect to the block-splitting sub-stage 704 shown in FIG. 7, the lines of pixels into which the encoded block 808 is split are parallel to one another and thus are oriented in the same direction. The lines of pixels of a given set generally will, but need not always, be spaced one or more lines apart within the encoded block 808. As such, sets of lines of pixels are interleaved within the encoded block 808. For example, where the encoded block 808 is split into two sets of lines of pixels including first lines of pixels and second lines of pixels, the first lines of pixels may be the odd numbered rows or columns of the encoded block 808 and the second lines of pixels may be the even numbered rows or columns of the encoded block 808. In such a case, the interleaving of the first and second lines of pixels is such that the first and second lines of pixels alternate with each row or column of the encoded block 808.

In some cases, a spatial sampling for the encoded block 808 may be encoded to the bitstream that includes the data associated with the encoded block 808. In such a case, the block splitting sub-stage 804 splits the encoded block 808 into the various sets of lines of pixels according to the signaled spatial sampling. In other cases, the block splitting sub-stage 804 may determine a spatial sampling and split the encoded block 808 into multiple sets of lines of pixels as described above with respect to the block splitting sub-stage 704. Although the block splitting sub-stage 804 is shown as being after the mode determination sub-stage 802 in FIG. 8, in some implementations, the block splitting performed by the block splitting sub-stage 804 may occur before or simultaneously with the mode determination performed by the mode determination sub-stage 802. For example, in some implementations, the mode determination sub-stage 802 and the block splitting sub-stage 804 may be combined into a single sub-stage of the prediction stage 800. In some such implementations, the combined sub-stage may read both the first intra prediction mode and the sampling strategy usable to identify where the first lines of pixels to be predicted using that first intra prediction mode are from the bitstream.

The multi-stage intra prediction sub-stage 806 performs intra prediction against sets of lines of pixels of the encoded block 808 in stages, starting with the first lines of pixels. The multi-stage intra prediction sub-stage 806 performs intra prediction against set of lines of pixels using an intra prediction mode determined for that set of lines of pixels. For example, the first lines of pixels are predicted using a first intra prediction mode, the second lines of pixels are predicted using a second intra prediction mode, and so on. In some examples, all sets of lines of pixels of the encoded block 808 may be predicted using the same intra prediction mode. In such a case, the first intra prediction mode used for the first lines of pixels and the second intra prediction mode used for the second lines of pixels may be the same intra prediction mode, and the second and subsequent intra prediction modes may be considered to have been inherited from the first intra prediction mode. In other examples, multiple sets of lines of pixels of the encoded block 808 may share a same intra prediction mode while other sets of lines of pixels of the encoded block 808 use a different intra prediction mode. In still further examples, each set of lines of pixels of the encoded block 808 may use a different intra prediction mode.

The multi-stage intra prediction sub-stage 806 performs intra prediction against sets of lines of pixels of the encoded block 808 using reference pixel data 812, which includes values of reconstructed pixels from one or more sources. In particular, for a given set of lines of pixels, the multi-stage intra prediction sub-stage 806 predicts the pixel values of the lines of pixels using an intra prediction mode for the lines of pixels and relevant reference pixel data 812. For example, the multi-stage intra prediction sub-stage 806 may predict first lines of pixels using a first intra prediction mode and reconstructed pixel values of neighbor blocks of the encoded block 808 as the reference pixel data 812. In another example, the multi-stage intra prediction sub-stage 806 may predict second lines of pixels using a second intra prediction mode inherited or derived from the first intra prediction mode and the reconstructed pixel values of the neighbor blocks and/or reconstructed values of the first lines of pixels as the reference pixel data 812. Thus, and as described above with respect to the multi-stage intra prediction sub-stage 706 shown in FIG. 7, the intra prediction mode used to predict a given set of lines of pixels is determined based on values of reconstructed pixels available for the prediction of the given set of lines of pixels. In this way, each stage of the multi-stage intra prediction process may benefit from the prediction of and reconstruction of (i.e., including application of any quantized prediction residual) previous sets of lines of pixels.

Once a given set of lines of pixels is predicted, the prediction residual associated with those lines of pixels and decoded from the bitstream is added to the predicted values to generate reconstructed pixel values for those lines of pixels. Those reconstructed pixel values will then be used for the prediction of the next set of lines of pixels. Thus, at each stage of the multi-stage intra prediction disclosed herein, the pixel values of a given set of lines that are reconstructed will have comparable accuracy for intra predicting a next set of lines of pixels as the pixel values in the one or more neighbor blocks of the encoded block 808. Once all sets of lines of pixels are predicted and reconstructed using their respective prediction residuals decoded from the bitstream, the reconstructed block 810 including the reconstructed pixel values of the various sets of lines of pixels is output for storage or further processing (e.g., for filtering prior to the ultimate output of a decoded block representing the video data of the reconstructed block 810).

Determining an intra prediction mode for each set of lines of pixels enables potential quality improvements by using more accurate reference data to more closely predict pixel values within the encoded block 808. That is, each pixel in a given line of pixels may be more accurately predicted than pixels in a previously predicted line of pixels because each pixel in the given line of pixels is predicted by one or more closely adjacent and fully reconstructed pixel values. For example, regardless of whether a prediction directionality changes between intra prediction modes used in subsequent sets of lines of pixels, the greater availability of adjacent, reconstructed pixel values will likely increase the prediction performance for a current line of pixels. Where the prediction directionality does change, however, as in some situations, a first intra prediction mode determined for first lines of pixels of the encoded block 808 may be suitable for the first lines of pixels, but not precise enough to accurately predict the second lines of pixels without unnecessary error. In one example, this may be where the first intra prediction mode is a first directional intra prediction mode and a prediction directionality other than that associated with the first directional intra prediction mode is better suited to predict second lines of pixels. For example, the first directional intra prediction mode may be a vertical prediction mode, and a second directional intra prediction mode to use for predicting the second lines of pixels may be +3 or +6 degrees away from that vertical prediction mode directionality given differences in the feature depicted in the second lines of pixels. As such, a directional intra prediction mode may be refined between predictions of sets of lines of pixels while performing the multi-stage intra prediction for the encoded block 808.

One reason why refinement may be desirable as further sets of lines of pixels are predicted is that additional reconstructed pixel values from lines of pixels that have already been predicted become available. For example, where the encoded block 808 is separated into first lines of pixels and second lines of pixels in which the first and second lines of pixels are interleaved in alternating rows or columns, a first line of pixels that is between two second lines of pixels is predicted based on reconstructed pixel values of neighbor blocks that do not actually border that first line of pixels. However, after that first line of pixels and the one two rows or columns over are both predicted, the resulting reconstructed pixel values, which do border a second line of pixels, may be used to improve the prediction accuracy for the second line of pixels by providing reference values that immediately surround the pixels of that second line of pixels. As such, a prediction directionality of a first intra prediction mode may be refined by considering multiple reconstructed pixel values surrounding pixel values of a second line of pixels to be predicted. This may, for example, be especially useful where there is a gradient or other pattern of change along the direction of prediction, or where a steep-angled edge intersects the first and second lines of pixels.

The spatial sampling determined (e.g., as decoded from the bitstream) for the encoded block 808, which guides the splitting of the encoded block 808 into the various sets of lines of pixels, can, for example, indicate to interleave two or more sets of lines of pixels on a 1 to N pattern basis, in which N is an integer greater than 1 and corresponding to a last set of lines of pixels. Generally, the spatial sampling determined for the encoded block 808 will follow powers of 2, such that the value of N will typically be equal to 2M, in which M is an integer starting at 1 for the second lines of pixels and increasing by 1 with each subsequent lines of pixels. However, this may not always be the case, as other spatial samplings may be used with the implementations of this disclosure.

Non-limiting examples of spatial samplings usable with the implementations of this disclosure will now be described. In one example, where the spatial sampling indicates to split the encoded block 808 in a 1 to 2 pattern, two sets of lines of pixels are split from the encoded block 808 and interleaved in an alternating pattern of first line, second line, first line, second line, first line, etc. In another example, where the spatial sampling indicates to split the encoded block 808 in a 1 to 3 pattern, three sets of lines of pixels are split from the encoded block 808 and interleaved in an alternating pattern of first line, second line, third line, first line, second line, third line, first line, etc. In some implementations, the spatial sampling may indicate a pattern other than one in which the sets of lines of pixels repeat in an evenly spaced pattern. For example, the spatial sampling may indicate to use a pyramid pattern in which the sets of lines of pixels are hierarchically arranged. In one example of a pyramid pattern, first lines of pixels are spaced apart by some number of lines (e.g., 4 or 8), second lines of pixels are spaced apart between the first lines of pixels, third lines of pixels are spaced apart between the second lines of pixels, and so on, based on the number of sets of lines of pixels. For example, with a pyramid pattern, subsequent sets of lines of pixels may potentially benefit from multiple sets of the same reconstructed pixel values surrounding them (e.g., in which two first lines surround two second lines that surround one third line), thereby potentially improving the quality of prediction for such subsequent sets of lines of pixels. The spatial sampling used at the prediction stage 800 is the same as the spatial sampling used at the prediction stage 700 shown in FIG. 7.

In some implementations, side information 814 encoded to a bitstream that includes the encoded block 808 may be used for predicting the encoded block 808. For example, the side information 814 may include or otherwise indicate one or more intra prediction modes determined and used for one or more sets of lines of pixels following first lines of pixels for which a first intra prediction mode is signaled within the bitstream, a spatial sampling for the encoded block 808, and/or the like. For example, the side information 814 may include data written to a block header of the encoded block 808. In another example, the side information 814 may include other data that will be made accessible in connection with the decoding of the encoded block 808.

In some implementations, quantizer delta values (e.g., delta values for quantization parameters) associated with the encoded block 808 may be included in the side information 814 or otherwise written to the bitstream for use with the encoded block 808 and/or the side information 814. For example, quantizer delta values for various sets of lines of pixels may be read from the bitstream to signal quantizer values to use as part of decoding those sets of lines of pixels. In some cases, the quantizer delta values are determined at an inverse quantization stage of the decoder that includes the prediction stage 800. In other cases, the quantizer delta values may be determined at the prediction stage 800, such as with access to quantization information from the inverse quantization stage of the decoder. In still other cases, the quantizer delta values may be derived from the bitstream. In either such case, in some implementations, the quantizer delta values may be specified at the block-level, frame-level, or sequence-level, or they could be derived or modified from a baseline value at the block-level, frame-level, or sequence-level based on block complexity. For example, a magnitude of a prediction residual decoded for a set of lines of pixels before a given set of lines of pixels may be used by the multi-stage intra prediction sub-stage 806 to modify a quantizer delta value for the given set of lines of pixels. In this way, the magnitude of the prediction residual operates as a form of proxy for complexity, as the prediction residual will tend to be larger where the subject video data is very complex and poorly predicted. In some implementations, as the quantizer used for encoding lines of pixels becomes higher in successive lines of pixels, the quantizer delta value that is encoded to the bitstream for a given set of lines of pixels may be relative to the actual quantizer (and its corresponding quantizer delta value) used in a previous set of lines of pixels.

In some implementations, the mode of prediction used to predict a set of lines of pixels may use an interpolation or extrapolation. For example, linear or polynomial interpolation may be performed to predict pixel values by interpolating from reconstructed pixel values nearby those pixel values to be predicted. In such a case, the interpolation predicts a pixel value based on an assumption that the pixel value will be somewhere in between the interpolated pixel values. In another example, contour modeling may be used to model edges within the encoded block 808 by interpolating based on reconstructed pixel values from adjacent lines of pixels, as applicable. In yet another example, a rate of change or other gradient representing differences between previously reconstructed pixel values can be extrapolated to predict pixel values that will follow that rate of change or other gradient. In some such implementations, a prediction directionality used to predict a previous set of lines of pixels may be refined for use with a next set of lines to be predicted based on such an interpolation or extrapolation.

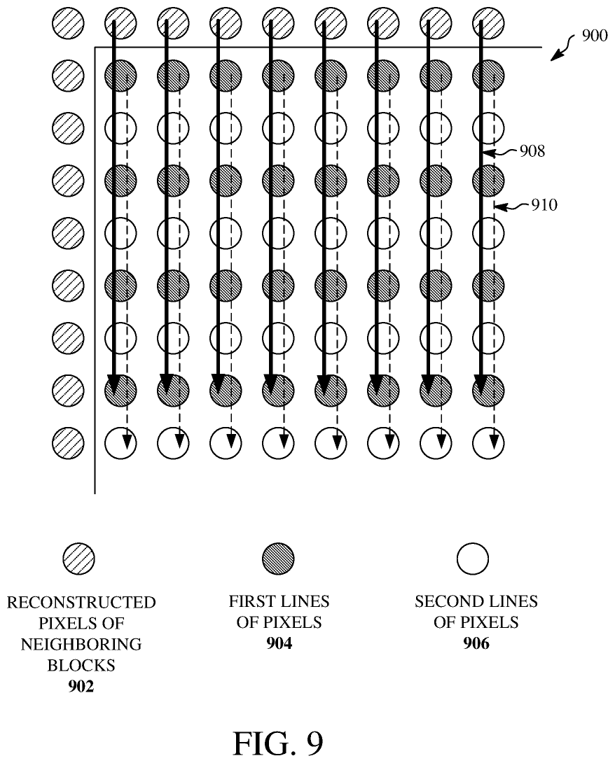

Reference is next made to example illustrations of pixels that may be processed using enhanced multi-stage intra prediction. FIG. 9 is an illustration of an example of a block 900 in which pixels are split into first and second lines and predicted using a same intra prediction direction. For example, the block 900 may be the block 708 shown in FIG. 7 or the encoded block 808 shown in FIG. 8. The block 900 is split into first lines of pixels 904 and second lines of pixels 906 interleaving the first lines of pixels 904 within the block 900. During a first stage intra prediction, a directional intra prediction mode and reconstructed pixels 902 of one or more neighboring blocks are used to predict first lines of pixels 904 within the block 900. As shown by the thick solid arrows 908, the first lines of pixels 904 are predicted using a vertical intra prediction mode and using values of the reconstructed pixels 902 from an above neighbor block of the block 900. A directional intra prediction mode to use for predicting the second lines of pixels 906 during a second stage intra prediction for the block 900 is then determined based on the vertical prediction mode used for the first lines of pixels 904. In this case, the vertical prediction mode is inherited from the first lines of pixels 904 and re-used for the second lines of pixels 906, as shown by the dashed arrows 910. Thus, the second lines of pixels 906 are predicted using the vertical intra prediction mode and using reconstructed values of the first lines of pixels 904. In some cases, the second lines of pixels 906 may be predicted using the vertical intra prediction mode and using both of the values of the reconstructed pixels 902 of the above neighbor block and values of the reconstructed first lines of pixels 904.

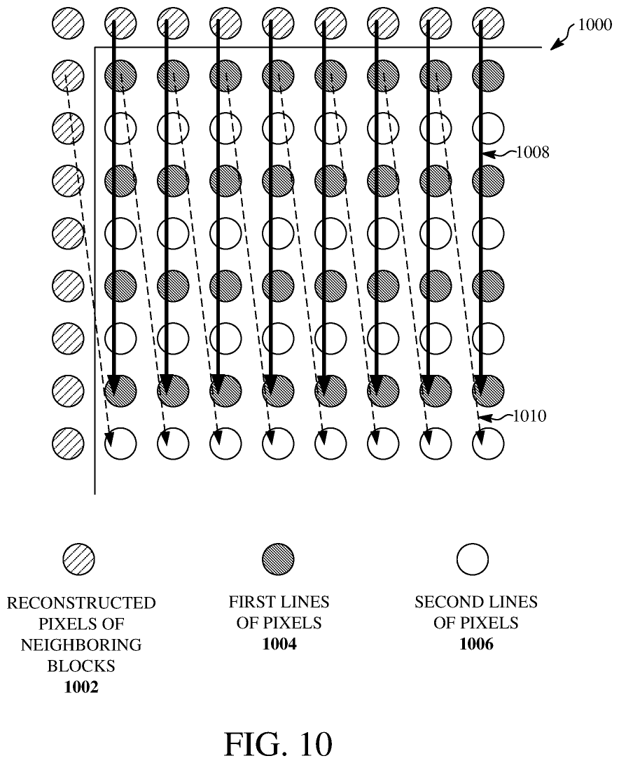

The mode of prediction is used alongside the direction of prediction to predict the second lines of pixels 906. In some implementations, the second lines of pixels 906 may be predicted using bilinear filtering. For example, a 2-tap bilinear filter that interpolates between reconstructed values of the first lines of pixels 904 may be used as the directional intra prediction mode for the second lines of pixels 906. In such a case, for a given pixel on a second line of pixels 906, the reconstructed value of the pixel on the first line of pixels 904 directly above the given pixel and the reconstructed value of the pixel on the first line of pixels 904 directly below the given pixel are used to determine the predicted value for the given pixel. For example, the predicted value for the given pixel may be the average of the reconstructed values of the above and below pixels from the two subject first lines of pixels 904. In some implementations, other interpolations, extrapolations, or modeling, such as described below with respect to FIG. 10, may be used.

FIG. 10 is an illustration of an example of a block 1000 in which pixels are split into first and second lines and predicted using different intra prediction directions. For example, the block 1000 may be the block 708 shown in FIG. 7 or the encoded block 808 shown in FIG. 8. The block 1000 is split into first lines of pixels 1004 and second lines of pixels 1006 interleaving the first lines of pixels 1004 within the block 1000. During a first stage intra prediction, a first directional intra prediction mode and reconstructed pixels 1002 of one or more neighboring blocks are used to predict first lines of pixels 1004 within the block 1000. As shown by the thick solid arrows 1008, the first directional intra prediction mode is a vertical intra prediction mode, and the first lines of pixels 1004 are predicted using that first directional intra prediction mode and using values of the reconstructed pixels 1002 from an above neighbor block of the block 1000. A second directional intra prediction mode to use for predicting the second lines of pixels 1006 during a second stage intra prediction for the block 1000 is then determined based on the first directional intra prediction mode. In this case, as shown by the dashed arrows 1010, the second directional intra prediction mode is different, but derived from the vertical intra prediction mode used for the first lines of pixels 1004. For example, an error metric used to determine intra prediction modes may indicate based on sub-sampled values that a better prediction of the second lines of pixels 1006 will result from the second directional intra prediction mode. In another example, for a given pixel, a 2-, 3-, 4-, 5-, or 6-tap bilinear filter using some or all reconstructed above-left, above, above-right, below-left, below, and below-right pixel values of that given pixel (i.e., from the line of pixels above the line that includes the given pixel and/or from the line of pixels below that line that includes the given pixel) may be used to determine the second directional intra prediction mode independent of an error metric measurement. Thus, the second lines of pixels 1006 are predicted using the second directional intra prediction mode and using reconstructed values of the first lines of pixels 1004.

The mode of prediction is used alongside the direction of prediction to predict the second lines of pixels 1006. In some implementations, bilinear filtering, as described above with respect to FIG. 9, may be used. In some implementations, the reconstructed values of the first lines of pixels 1004 that are above and below values of the second lines of pixels 1006 may be used to predict those values of the second lines of pixels 1006 using a linear or polynomial interpolation. For example, rather than the second lines of pixels 1006 merely inheriting the first directional intra prediction mode from the first lines of pixels 1004, the first directional intra prediction mode, and moreover the reconstructed values of the first lines of pixels 1004 resulting from predicting the first lines of pixels 1004 using the first directional intra prediction mode, may be used to refine the direction of prediction to use for the second lines of pixels 1006 from the first directional intra prediction mode to the second directional intra prediction mode. In some such implementations, certain graphic methods, inpainting, or contour methods may be used to refine the direction of prediction for the second lines of pixels 1006 instead of a linear or polynomial interpolation.

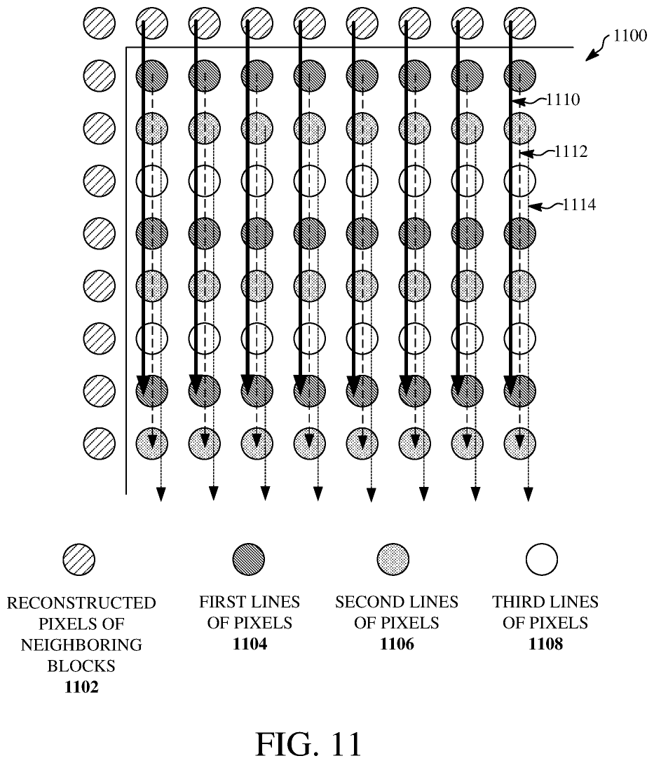

FIG. 11 is an illustration of an example of a block 1100 in which pixels are split into more than two sets of lines. For example, the block 1100 may be the block 708 shown in FIG. 7 or the encoded block 808 shown in FIG. 8. The block 1100 is split into interleaving first lines of pixels 1104, second lines of pixels 1106, and third lines of pixels 1108 within the block 1100. During a first stage intra prediction, a directional intra prediction mode and reconstructed pixels 1102 of one or more neighboring blocks are used to predict first lines of pixels 1104 within the block 1100. As shown by the thick solid arrows 1110, the first lines of pixels 1104 are predicted using a vertical intra prediction mode and using values of the reconstructed pixels 1102 from an above neighbor block of the block 1100. A directional intra prediction mode to use for predicting the second lines of pixels 1106 during a second stage intra prediction for the block 1100 is then determined based on the vertical prediction mode used for the first lines of pixels 1104. In this case, the vertical prediction mode is inherited and thus re-used for the second lines of pixels 1106, as shown by the dashed arrows 1112. Thus, the second lines of pixels 1106 are predicted using the vertical intra prediction mode and using reconstructed values of the first lines of pixels 1104. A directional intra prediction mode to use for predicting the third lines of pixels 1108 during a third stage intra prediction for the block 1100 is then determined based on the vertical prediction mode used for the second lines of pixels 1106. In this case, the vertical prediction mode is again inherited and thus re-used for the third lines of pixels 1108, as shown by the dotted arrows 1114. Thus, the third lines of pixels 1108 are predicted using the vertical intra prediction mode and using reconstructed values of the second lines of pixels 1106. In at least some cases, the second lines of pixels are also predicted using the reconstructed pixels 1102 and/or the third lines of pixels are also predicted using the reconstructed pixels 1102 and the reconstructed values of the first lines of pixels.

In some implementations, a rate of change or other gradient evaluating changes in reconstructed pixel values across different lines of pixels can be evaluated to determine an intra prediction mode for later lines of pixels. For example, the third lines of pixels 1108 may be predicted based on a rate of change or other gradient using a prediction directionality that is +9 degrees from the vertical intra prediction mode and using a combination of two or more of the values of the reconstructed pixels 1102 of the above neighbor block, reconstructed values of the first lines of pixels 1104, or reconstructed values of the second lines of pixels 1106. For example, the reconstructed pixels 1102 may be processed to determine to predict the first lines of pixels 1104 using an intra prediction mode that is +3 degrees from a vertical intra prediction mode, the reconstructed first lines of pixels 1104 may be processed to determine to predict the second lines of pixels 1106 using an intra prediction mode that is +6 degrees from the vertical intra prediction mode. This rate of change may thus be extrapolated to determine that a further +3 degrees from the vertical intra prediction mode should be added for predicting the third lines of pixels 1106.

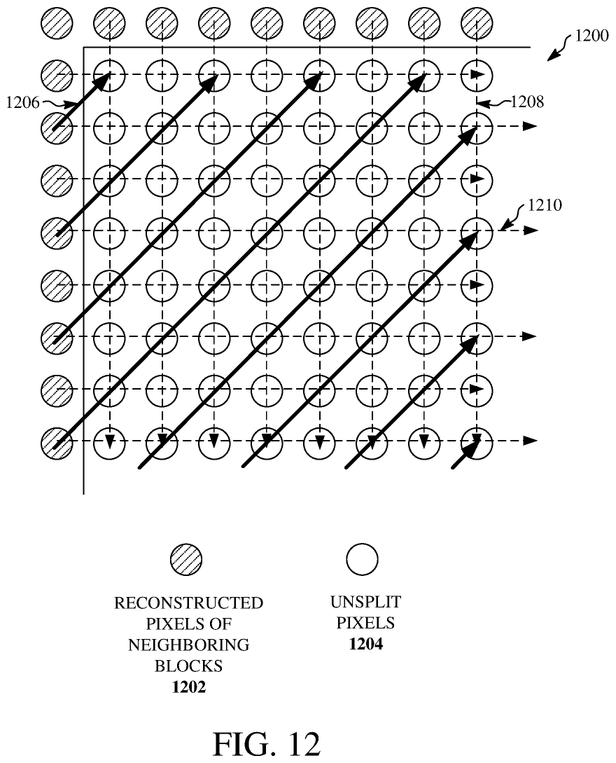

FIG. 12 is an illustration of an example of a block 1200 in which a sub-sampled 45-degree prediction directionality is determined for identifying the first lines of pixels. For example, the block 1200 may be the block 708 shown in FIG. 7 or the encoded block 808 shown in FIG. 8. The block 1200 is surrounded on left and above sides by reconstructed pixels 1202 of neighboring blocks. The block 1200 includes unsplit pixels 1204 that will be split into at least first lines of pixels and second lines of pixels based on the prediction directionality for the block 1200, which is or otherwise refers to an initial prediction mode for the block 1200. In this case, as shown by the thick solid arrows 1206, the initial prediction mode is a 45-degree intra prediction mode. Because the 45-degree direction is equidistant to the vertical and horizontal directions, the block 1200 may be split into columns (i.e., such that the lines of pixels will run vertically across the block in the direction of arrows 1208) or rows (i.e., such that the lines of pixels will run horizontally across the block 1200 in the direction of arrows 1210). The spatial sampling indicating such a split may be signaled to a decoder within a bitstream. In some cases, the first lines of pixels for the block 1200 may follow the 45-degree intra prediction mode angle, such as where the pixels under each of the arrows 1206 are treated as the first lines of pixels. In such a case, the unsplit pixels 1204 may be split into the first lines of pixels underneath the arrows 1206 and second lines of pixels in the alternating diagonal lines between the arrows 1206.

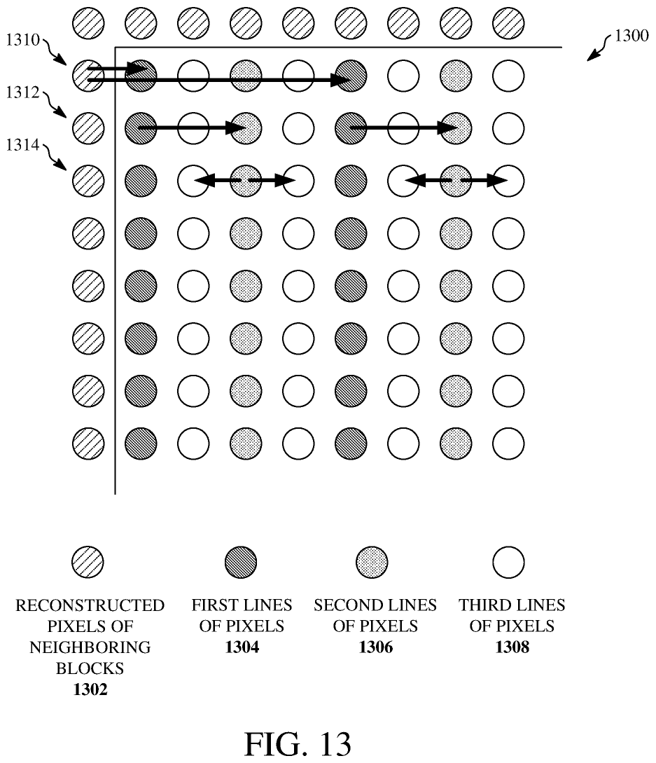

FIG. 13 is an illustration of an example of a block 1300 in which pixels are predicted in a pyramid pattern. For example, the block 1300 may be the block 708 shown in FIG. 7 or the encoded block 808 shown in FIG. 8. The block 1300 is surrounded on left and above sides by reconstructed pixels 1302 of neighboring blocks. The block 1300 includes first lines of pixels 1304, second lines of pixels 1306, and third lines of pixels 1308. The various pixels of the block 1300 are split into the lines of pixels 1304 through 1308 in a pyramid pattern. According to this pyramid pattern, the first lines of pixels 1304 are spaced every fourth column in the block 1300 and are predicted using a first intra prediction mode and values of the reconstructed pixels 1302, shown by arrows in a first row 1310 of the block 1300. The second lines of pixels 1306, which are predicted using a second intra prediction mode (e.g., which may be inherited or derived from the first intra prediction mode) shown by arrows in a second row 1312 of the block 1300, are spaced evenly between the first lines of pixels 1304, and thus two columns away from the first lines of pixels 1304 and four columns away from each other. The third lines of pixels 1308, which are predicted using a third intra prediction mode (e.g., which may be inherited or derived from the second intra prediction mode) shown by arrows in a third row 1314 of the block 1300, are spaced evenly between the second lines of pixels 1306 and the first lines of pixels 1304, and thus two columns away from each other. In this example, the third lines of pixels 1308, being in a lower level of the hierarchical arrangement of the pyramid pattern than the first lines of pixels 1304 and the second lines of pixels 1306, are predicted using the benefit of the reconstructed values of the reconstructed pixels 1302, the reconstructed first lines of pixels 1304, and the reconstructed second lines of pixels 1306 (although in some cases only one or two of those sets of reconstructed pixels/lines of pixels may instead be used). As a result, the predicted values of the third lines of pixels 1308 are likely to be closer to their original values than the predicted values of the first lines of pixels 1304 or the predicted values of the second lines of pixels 1306. Thus, the encoding of the reconstructed third lines of pixels 1308 within a bitstream will require fewer bits than that of either of the reconstructed first lines of pixels 1304 or the reconstructed second lines of pixels 1306.

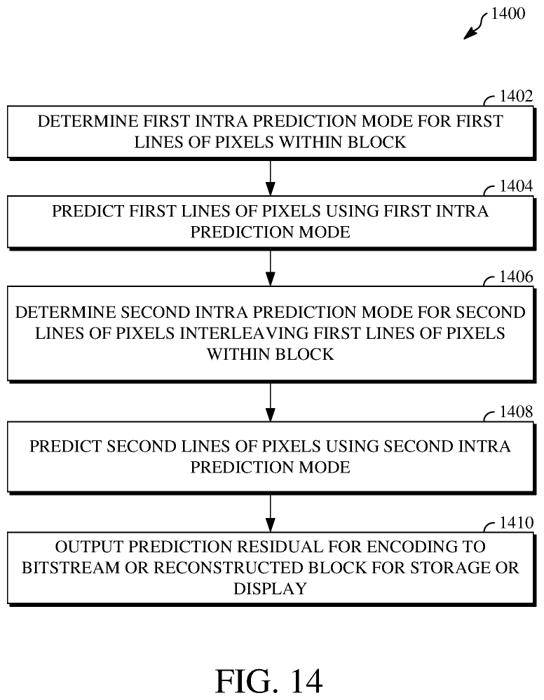

Further details of techniques for enhanced multi-stage intra prediction are now described. FIG. 14 is a flowchart diagram of an example of a technique 1400 for enhanced multi-stage intra prediction. The technique 1400 can be implemented, for example, as a software program that may be executed by computing devices such as the transmitting station 102 or the receiving station 106. For example, the software program can include machine-readable instructions that may be stored in a memory such as the memory 204 or the secondary storage 214, and that, when executed by a processor, such as the processor 202, may cause the computing device to perform the technique 1400. The technique 1400 can be implemented using specialized hardware or firmware. For example, a hardware component configured to perform the technique 1400. As explained above, some computing devices may have multiple memories or processors, and the operations described in the technique 1400 can be distributed using multiple processors, memories, or both. For simplicity of explanation, the technique 1400 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1402, a first intra prediction mode (e.g., a first directional intra prediction mode) is determined for first lines of pixels within a block or encoded block as the case may be based on whether the prediction is being performed as part of an encoding or decoding process. The first lines of pixels are one of at least two sets of lines of pixels into which the block or encoded block is split for multi-stage intra prediction. As will be described in this example of the technique 1400, the block or encoded block may be split into first lines of pixels and second lines of pixels interleaving the first lines of pixels within the block or encoded block. For example, the first lines of pixels may be odd numbered rows or columns of the block or encoded block and the second lines of pixels may be even numbered rows or columns of the block or encoded block. In some cases, the first intra prediction mode may be the same as an initial intra prediction mode determined for the block or encoded block. In other cases, the first intra prediction mode may be different from but still determined based on an initial intra prediction mode determined for the block or encoded block. In some cases, determining the first intra prediction mode can include, during decoding, decoding one or more syntax elements indicative of the first intra prediction mode from a bitstream to which the encoded block data is also written.

At 1404, the first lines of pixels are predicted using the first intra prediction mode. During encoding, predicting the first lines of pixels includes determining predicted values for the pixels of the first lines of pixels within the block and determining error values (e.g., prediction residual values) for the first lines of pixels based on those predicted values. During decoding, predicting the first lines of pixels includes determining predicted values for the pixels of the first lines of pixels within the encoded block and reconstructing the first lines of pixels by adding the error values (e.g., prediction residual values) corresponding to the first lines of pixels to those predicted values. In either case, the first lines of pixels are predicted according to the first directional intra prediction mode while skipping the second lines of pixels. That is, the second lines of pixels are not predicted until after the prediction (and subsequent reconstruction) of the first lines of pixels. The first lines of pixels are predicted using reconstructed pixel values of one or more neighbor blocks of the block or encoded block as predicted values.

At 1406, a second intra prediction mode (e.g., a second directional intra prediction mode) is determined for the second lines of pixels. The second intra prediction mode is determined based on the first intra prediction mode. In particular, the first intra prediction mode and the second intra prediction mode may be the same or different intra prediction modes. For example, the second intra prediction mode may be inherited from or otherwise derived using the first intra prediction mode. In one non-limiting example, the first directional intra prediction mode and the second directional intra prediction mode are both a vertical prediction mode or a horizontal prediction mode. In such a case, the vertical or horizontal prediction mode used as the second intra prediction mode may be considered inherited from the first intra prediction mode.

At 1408, the second lines of pixels are predicted using the second intra prediction mode and at least the reconstructed first lines of pixels. During encoding, predicting the second lines of pixels includes determining predicted values for the pixels of the second lines of pixels within the block and determining error values (e.g., prediction residual values) for the second lines of pixels based on those predicted values. During decoding, predicting the second lines of pixels includes determining predicted values for the pixels of the second lines of pixels within the encoded block and reconstructing the second lines of pixels by adding the error values (e.g., prediction residual values) corresponding to the second lines of pixels to those predicted values. In either case, the second lines of pixels are not predicted until after the prediction and subsequent reconstruction of the first lines of pixels. The second lines of pixels are predicted using the reconstructed first lines of pixels as predicted values and, in some cases, using the reconstructed pixel values of one or more neighbor blocks of the block or encoded block in addition to those reconstructed first lines of pixels as the predicted values. In some implementations, pixels of the second lines of pixels are predicted using bilinear filtering, linear interpolation, polynomial interpolation, or contour modeling performed against two or more pixels of the first lines of pixels that are adjacent to the pixels of the second lines of pixels.

At 1410, data produced based on the predictions of the first and second lines of pixels is output. For example, during encoding, prediction residuals each representing a difference between actual and predicted values of a given set of lines of pixels of the block are output, such as for further processing prior to encoding to a bitstream. In another example, during decoding, a reconstructed block including the reconstructed first lines of pixels and the reconstructed second lines of pixels is output further processing, such as prior to being output within an output video stream. For example, during decoding, a final output may be a decoded block (including the reconstructed first lines of pixels and the reconstructed second lines of pixels) output for storage or further processing.

In some implementations, the technique 1400 may include splitting the block or encoded block, as the case may be, into the sets of lines of pixels. For example, the technique 1400 may include determining a spatial sampling for the block or encoded block based on an intra prediction mode (e.g., an initial intra prediction mode determined for the block during encoding or the first intra prediction mode signaled within the bitstream for the encoded block during decoding), and splitting the block or encoded block into the various sets of lines of pixels (e.g., the first lines of pixels and the second lines of pixels) according to the spatial sampling. In some such implementations, the spatial sampling is determined using a decision tree. In some such implementations, during decoding, the spatial sampling is determined using one or more syntax elements encoded to a bitstream including the encoded block. In some such implementations, the technique 1400 may include determining the initial intra prediction mode for the block or encoded block. In some such implementations, the technique 1400 may include, during encoding, determining that the initial prediction mode for the block or encoded block is a 45-degree intra prediction mode, and, based on the initial prediction mode, identifying the first lines of pixels as either odd-numbered rows within the block or odd-numbered columns within the block. The technique 1400 may thus further include signaling the spatial sampling indicating the identification of the first lines of pixels as the odd-numbered rows or odd-numbered columns within the bitstream.

In some implementations, the block or encoded block may be split into more than two sets of lines of pixels. For example, the spatial sampling may indicate to predict the encoded block using a pyramid pattern within which sets of lines of pixels including the first lines of pixels and the second lines of pixels are hierarchically arranged. In some such implementations, the technique 1400 may include determining, based on the second intra prediction mode, a subsequent intra prediction mode (e.g., a third, fourth, etc. directional intra prediction mode) for the subsequent (e.g., third, fourth, etc.) lines of pixels interleaving the first lines of pixels and the second lines of pixels within the block or encoded block at a level of the pyramid pattern that is hierarchically below a level to which the second lines of pixels correspond, and predicting those subsequent lines of pixels using the subsequent intra prediction mode. For example, during decoding, predicting third lines of pixels may include reconstructing the third lines of pixels using the reconstructed second lines of pixels as predicted values, and, in at least some cases, additionally using the reconstructed first lines of pixels and the reconstructed values of the neighbor blocks as reference pixel values. Similarly, where fourth lines of pixels are on a same level of the pyramid pattern as the third lines of pixels, predicting the fourth lines of pixels may include reconstructing the fourth lines of pixels using the reconstructed second lines of pixels as predicted values, and, in at least some cases, additionally using the reconstructed first lines of pixels and the reconstructed values of the neighbor blocks as reference pixel values. Alternatively, where the fourth lines of pixels are on a hierarchically lower level of the pyramid pattern than the third lines of pixels, predicting fourth lines of pixels may include reconstructing the fourth lines of pixels using the reconstructed third lines of pixels as predicted values, and, in at least some cases, additionally using the reconstructed second lines of pixels, the reconstructed first lines of pixels, and the reconstructed values of the neighbor blocks as reference pixel values.

In some such implementations, the spatial sampling indicates to split the encoded block into the first lines of pixels, the second lines of pixels, the third lines of pixels, the fourth lines of pixels, and any other lines of pixels used. In some such implementations, subsequent intra prediction modes may be inherited from previous intra prediction modes, and the subsequent lines of pixels may be determined using the previously reconstructed pixels of neighbor blocks and/or previously predicted lines of pixels. For example, where a pyramid pattern is used and the block is split into four different sets of lines of pixels in which the third lines of pixels and the fourth lines of pixels are on a same level of the pyramid hierarchy and the second lines of pixels are on a next higher level thereof, the third intra prediction mode used for predicting the third lines of pixels and the fourth intra prediction mode used for predicting the fourth lines of pixels may both be inherited or otherwise derived from the second intra prediction mode used for predicting the second lines of pixels. In some such implementations, the technique 1400 may include determining a rate of change representing differences between the previously reconstructed pixels, the reconstructed first lines of pixels, and/or the reconstructed second lines of pixels, and refining the third directional intra prediction mode using a filter extrapolated based on the rate of change. In some implementations, the first directional intra prediction mode is the initial directional prediction mode, and the spatial sampling indicates to split the encoded block into a number of sets of lines of pixels equal to a power of two.

In some implementations of the technique 1400, different quantizer delta values used for the various lines of pixels are derived. In some such implementations, a quantizer delta value used for a given set of lines of pixels (e.g., the second lines of pixels) may be encoded to the bitstream relative to a quantizer and/or a corresponding quantizer delta value used for an immediately preceding set of lines of pixels (e.g., the first lines of pixels).

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

Implementations of the transmitting station 102 and/or the receiving station 106 (and the algorithms, methods, instructions, etc., stored thereon and/or executed thereby, including by the encoder 400 and the decoder 500, or another encoder or decoder as disclosed herein) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized that can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102 can encode content into an encoded video signal and transmit the encoded video signal to the communications device. In turn, the communications device can then decode the encoded video signal. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device.

Further, all or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described implementations and other aspects have been described to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law to encompass all such modifications and equivalent arrangements.

1. A method for decoding an encoded block, comprising:
determining a first directional intra prediction mode for first lines of pixels within the encoded block;
reconstructing the first lines of pixels using the first directional intra prediction mode;
determining, based on the first directional intra prediction mode, a second directional intra prediction mode for second lines of pixels interleaving the first lines of pixels within the encoded block;
reconstructing the second lines of pixels using the second directional intra prediction mode and at least the reconstructed first lines of pixels; and
outputting a decoded block including the reconstructed first lines of pixels and the reconstructed second lines of pixels for storage or further processing.

2. The method of claim 1, wherein reconstructing the first lines of pixels comprises:
predicting the first lines of pixels according to the first directional intra prediction mode while skipping the second lines of pixels.

3. The method of claim 1, wherein the first lines of pixels are predicted using previously reconstructed pixels of one or more neighbor blocks of the encoded block, and wherein the second lines of pixels are predicted using both the previously reconstructed pixels of the one or more neighbor blocks and the reconstructed first lines of pixels.

4. The method of claim 1, wherein the first lines of pixels are odd numbered rows or columns of the encoded block, and the second lines of pixels are even numbered rows or columns of the encoded block.

5. The method of claim 1, wherein the second directional intra prediction mode is inherited from the first directional intra prediction mode.

6. The method of claim 1, wherein pixels of the second lines of pixels are predicted using linear interpolation or polynomial interpolation performed against one or both of pixels of the first lines of pixels that are adjacent to the pixels of the second lines of pixels or previously reconstructed pixels of one or more neighbor blocks of the encoded block that are adjacent to the pixels of the first lines of pixels.

7. The method of claim 1, comprising:
determining a spatial sampling for the encoded block; and
splitting the encoded block into the first lines of pixels and the second lines of pixels according to the spatial sampling.

8. The method of claim 7, wherein the spatial sampling indicates to predict the encoded block using a pyramid pattern within which sets of lines of pixels including the first lines of pixels and the second lines of pixels are hierarchically arranged, the method comprising:
determining, based on the second directional intra prediction mode, a third directional intra prediction mode for third lines of pixels interleaving the first lines of pixels and the second lines of pixels within the encoded block at a level of the pyramid pattern that is hierarchically below a level to which the second lines of pixels correspond; and
reconstructing the third lines of pixels using the third directional intra prediction mode and at least the reconstructed second lines of pixels.

9. The method of claim 8, wherein the third directional intra prediction mode is inherited from the second directional intra prediction mode, and wherein the third lines of pixels are reconstructed using previously reconstructed pixels of one or more neighbor blocks of the encoded block, the reconstructed first lines of pixels, and the reconstructed second lines of pixels.

10. The method of claim 9, comprising:
determining a rate of change representing differences between the previously reconstructed pixels of the one or more neighbor blocks, the reconstructed first lines of pixels, and the reconstructed second lines of pixels; and
refining the third directional intra prediction mode using a filter extrapolated based on the rate of change.

11. The method of claim 7, wherein the spatial sampling is determined using one or more syntax elements encoded to a bitstream including the encoded block.

12. The method of claim 11, wherein a first quantizer delta value used for the first lines of pixels and a second quantizer delta value used for the second lines of pixels are derived from the bitstream, and wherein the second quantizer delta value is encoded to the bitstream relative to one or both of a quantizer used for the first lines of pixels or the first quantizer delta value.

13. The method of claim 7, wherein the first directional intra prediction mode is an initial directional prediction mode, and the spatial sampling indicates to split the encoded block into a number of sets of lines of pixels that is equal to a power of two.

14. An apparatus for decoding an encoded block, comprising:
a memory; and
a processor configured to execute instructions stored in the memory to:
reconstruct first lines of pixels within the encoded block using a first directional intra prediction mode;
reconstruct second lines of pixels interleaving the first lines of pixels within the encoded block using the reconstructed first lines of pixels and a second directional intra prediction mode determined based on the first directional intra prediction mode; and
output a decoded block including the reconstructed first lines of pixels and the reconstructed second lines of pixels for storage or further processing.

15. The apparatus of claim 14, wherein the processor is configured to execute the instructions to:
determine the first lines of pixels based on a spatial sampling for the encoded block, wherein the spatial sampling is based on the first directional intra prediction mode.

16. The apparatus of claim 15, wherein the processor is configured to execute the instructions to:
decode the first directional intra prediction mode from a bitstream to which the encoded block is encoded;
decode the spatial sampling from the bitstream; and
split the encoded block into at least the first lines of pixels and the second lines of pixels according to the spatial sampling.

17. The apparatus of claim 14, wherein multiple sets of lines of pixels within the encoded block including the first lines of pixels and the second lines of pixels are predicted in a pyramid pattern.

18. A non-transitory computer-readable storage device including program instructions executable by one or more processors that, when executed, cause the one or more processors to perform operations for decoding an encoded block, the operations comprising:
splitting the encoded block into first lines of pixels and second lines of pixels according to a spatial sampling for the encoded block;
reconstructing first lines of pixels within the encoded block using a first directional intra prediction mode;
reconstructing second lines of pixels interleaving the first lines of pixels within the encoded block using the reconstructed first lines of pixels and a second directional intra prediction mode inherited from the first directional intra prediction mode; and
output a decoded block including the reconstructed first lines of pixels and the reconstructed second lines of pixels for storage or further processing.

19. The non-transitory computer-readable storage device of claim 18, wherein the spatial sampling identifies the first lines of pixels as either odd-numbered rows within the encoded block or odd-numbered columns within the encoded block.

20. The non-transitory computer-readable storage device of claim 18, wherein the spatial sampling is determined using a decision tree.
